(19) United States
(12) Patent Application Publication
(10) Pub. No.: US 2006/0166371 A1
(43) Pub. Date: Jul. 27, 2006

(54) System for establishing a sample cover on a substrate

(75) Inventors: Gregory A. Testa, Medfield, MA (US); Hans A. Hug, Weston, MA (US)

Correspondence Address: Thomas F. Cooney, Patent Admin.;DakoCytomation Colorado, Inc., 4850 Innovation Drive, Fort Collins, CO, 80525, US

(73) Assignee: DakoCytomation Denmark A/S, Glostrup (DK)

(21) Appl. No.: 11/224,730

(22) Filed: Sep. 12, 2005

Related U.S. Application Data
(63) Continuation of application No. PCT/DK04/00179, filed on Mar. 18, 2004.
(60) Provisional application No. 60/456,369, filed on Mar. 20, 2003.

(51) Int. Cl. G01N 1/00

(52) U.S. Cl. 436/174

(57) ABSTRACT

The invention provides a manually operated or automated clamping means to seal a solid support substrate to a solid support cover creating a uniform environmental chamber above a specimen mounted to the support substrate. The clamping means may consist of several components that may act ad a system to provide a repeatable and uniform clamping load to the substrate and cover.

### I. BACKGROUND

This invention relates to a novel clamping device for providing repetitive and uniform compression of a solid support cover to a solid support substrate with a biological sample mounted on it (i.e. a glass microscope slide). The clamping device may also create a seal by compressing a sealing material (i.e. a gasket, o-ring or similar material) between the cover and the solid support substrate. The invention may also eliminate the inherent variability in clamping force developed by users with different physical abilities.

One embodiment of the present invention describes a clamping device that may be used to secure a solid support cover to a solid support substrate with a biological specimen on the surface apposed to the cover. The clamp is innovative in that it provides uniform clamping force along the edges of the cover, minimizes the potential for broken support substrates, and is not dependent on the user's physical abilities.

Biological specimens (i.e. tissue samples, DNA/RNA arrays, protein arrays, cell smears, and the like) mounted to solid support substrates such as glass microscope slides or membrane materials may be processed with a variety of techniques including standard cytochemistry staining methods (immunohistochemistry, hematoxylin/eosin & special stains), in-situ hybridization of DNA or RNA targets and probes (microarrays), and protein-protein binding (protein arrays). Many of these techniques require elevated temperatures up to about 95° C. for processing. Reagents can be very costly to the end user so there is a need to reduce the volume of reagents used in processing the biological specimens.

Specimens that are manually processed may use volumes on the order of 10-20 μL (micro-liter) per sample. Reagents may be pipetted onto the specimen and a thin glass coverslip may be placed over the biological specimen. A very small capillary gap may then be formed between the solid support and the coverslip. To prevent or minimize evaporation of the reagent at elevated temperatures, the coverslip may be sometimes sealed to the substrate by applying rubber cement or nail polish around the edges. Other methods may place the substrate with the coverslip into a container with excess solution to prevent evaporation of the reagent during heating.

Automated immunohistochemistry (IHC), in-situ hybridization (ISH), fluorescent in-situ hybridization (FISH) and protein array instruments may be finding increase use in both the clinical and research facilities now that the human genome has been mapped. The instruments may be used in areas such as drug discovery, gene expression, toxicology studies, sequencing, disease diagnosis, therapeutic monitoring, and the like.

The challenge arises when the manual process is automated. Automated instruments currently on the market typically require significantly higher volumes of reagents as compared to the manual process. Covers of different designs and volumes have been used to minimize the volume of reagents used in automated processing of the specimens. For example, an opaque cover may be used for light sensitive assays or the like. But the volumes may be 5-10 times the volumes of manual processing. The covers have been attached, for example, with pressure-sensitive adhesives or clamped to the solid support substrates. Adhesive attached covers do not easily lend themselves to automation. However, clamping devices may be better suited for integration into automated instruments. Typically, the solid support substrates, such as but not limited to glass or silicon slides, may be brittle and may be damaged easily if the clamping force is too high or concentrated over a portion of the substrate. Several clamping designs have found use in automated instruments due to their ease of use. The clamping designs include, but are not limited to: rotating or pivotal clamps; screw-type clamps; combination of pivotal and screw-type clamps; spring loaded clamps; cam rollers/parallelogram actuator; and hooks/linkages.

The clamps provide the compressive force required to seal the cover to the solid substrate. However, the existing clamping mechanisms have several inherent deficiencies including, but not limited to the following discussion: (1) some of the known clamping mechanisms have broken substrates due to excessive or concentrated forces, which may amount to a non-uniform force distribution. (The problem of broken substrates can be exacerbated with heating, for example at 95° C., which can lead to higher internal stresses when a non-uniform force distribution is applied. Microarrays may be costly to replace, for example, it may cost upwards to $1000 per substrate, which does not include the labor for set-up.); (2) the user's physical abilities or discretion may define clamp force; (3) variable chamber volumes may be due to varying chamber heights caused by inadequate (for example, too high or too low) clamping force; (4) air bubble formation over the biological specimen may be caused by seal leaks or too high a chamber volume as compared to the dispensed reagent volume; (5) lack of ergonomics, for example, screw-type clamps may require multiple turns of the screws to develop necessary clamp force; (6) each clamp assembly may need to be individually adjusted/calibrated during manufacture/assembly to attain proper clamping force; and (7) variability of standard compression springs may be as high as 15%-20% from spring to spring.

A novel clamping device is required to repeatedly secure the cover to the solid support substrate without damaging the substrate and to maintain constant internal volume within the sealed chamber.

It may be well known that in order to form a sealed chamber over a solid support, several key components are required. These may include, but are not limited to, a base plate, a top plate with an integral seal (o-ring, gasket, adhesive, etc.), and a means to compress the seal between the top and bottom plates. In the biotechnology field, the base plate may be a solid support substrate such as a glass microscope slide, silicon, ceramic or similar material or element. The top plate may be in the form of a cover or cassette holder, which may be fabricated from plastic, elastomeric, metallic, glass, silicon, ceramic, and the like, etc. The seals may come in a variety of shapes and materials. The shape of the seal may be circular similar to that of an o-ring; square or rectangular like a gasket; an adhesive such as a pressure sensitive adhesive; or any other shape. Seal materials may be silicone rubber, neoprene, EPDM, Kalrez, pressure sensitive adhesives, etc.

Without a means to compress the seal between the top and bottom plates, a sealed chamber may not be formed since the weight of the top plate or cover may be very low. Several clamping designs have attempted to provide a means to compress the seal to form a sealed chamber. However, they have their disadvantages.

U.S. Pat. Nos. 5,958,760 and 6,395,536, both issued to Freeman describe a clamping mechanism consisting of a rotating angle arm with a rotatable chamber near the end of the one of the arms. These patents also describe a compression spring loaded mounting pins that biases the chamber towards the glass slide and may provide the clamp force once the clamp is locked into place. The clamp is locked into place with a manually actuated rotating hook. This design utilizes many different fabricated components each with possibly its own tolerances. Tolerances may stack up and may become an issue with increased part count. The mechanism also uses compression springs. Compression spring rate may vary from spring to spring 10% -15% (according to manufacturers' specifications) which may affect the final clamping force. In order to secure the clamp with the hook lock, the user pushes down on the clamp so the lock passes the hook (over travel), then the hook may be engaged and the clamp will release a slight amount from its maximum over travel position. The amount of over travel of the clamp may vary from one user to the next due to their physical abilities. Over travel may increase the loading (increasing internal stresses) on the glass slide to the point where it may break the slide. All these factors can add up to a situation that increases the potential for slide breakage and may vary the total volume of fluid above the biological specimen thus changing reaction conditions.

U.S. Pat. Nos. 6,238,910 and 6,432,696, both issued to Custance et al., describe a clamp mechanism where the clamp is secured by rotating a threaded fastener. The clamping mechanism seals a plastic chamber over two individual glass slides. If only one slide needs to be processed then a “dummy” slide is required to be inserted into the second position for the clamp to work as intended. The design also uses compression-type springs mounted in threaded fasteners. As previously mentioned compression springs may have variations in the spring rate of 10%-15%. There may also be variations due to the total angular rotation of the threaded fastener securing the springs. However, the largest variation may be due to the threaded fastener that secures the clamp mechanism to the base frame. The total angular rotation of this fastener may vary from user to user and also within a single user. Multiple rotations of the fastener may be required, and a user's physical strength may determine how far the fastener is turned. If the fastener is turned too far slide breakage may be possible. If the fastener is turned too little, the seal may leak or the total reagent volume inside the chamber may vary. The design also uses many components in its assembly, and the fabrication tolerance stack up may become an issue.

U.S. Pat. Nos. 5,695,942 and 5,695,454, issued to Farmilo et al., describe a leaf spring that is used to clamp and seal glass slides to the cell body. Variations in the spring rate may vary from 10% -15% from one spring to another, according to manufacturers' specifications. The leaf spring may not uniformly apply the load to the slide, which may lead to slight bending of the slide or possibly slight angular rotation of the slide. Additionally, the slide is inserted into a receptacle contacting the leaf spring during the entire insertion/removal process. The slide may experience the full effect of the leaf spring force throughout the insertion/removal procedure. Leaf springs may exert high forces in order to ensure tight contact of the slide with the cell block. The operator may be required to exert a relatively high force to insert/remove the slides. If the user applies a force to the slide at too much of an angle off the linear length axis of the slide, the slide may break due to high cantilever loading. As an alternative approach, the patent, describes the possibility of using a piston instead of the leaf spring for biasing the slide to the cell body. This concept may have its own inherent issues, which may include localized force loading (right at the contact area of the piston and the slide) which can lead to broken slides.

U.S. Pat. No. 5,192,503 to McGrath et al., also uses leaf springs for clamping purposes. This design may have many of the same issues as the leaf spring design in U.S. Pat. Nos. 5,695,942 and 5,965,454 to Farmilo et al.

U.S. Pat. No. 5,273,905 to Muller et al., describes a dual cam and roller/parallelogram linkage clamp to seal a block assembly to a glass slide. The cams are eccentric and when rotated to a desired angle they apply a force. The patent describes how individual adjustments may need to be made to each clamp assembly to insure face-to-face engagement of the slide to the bloc/clamp assembly. The adjustments may be in the form of shims. This clamp design may be unique, but it is not a simple one. There may be far too many parts that can easily increase the tolerance stack up for the clamp assembly. This is most likely why individual adjustments are necessary. Additionally, the design does not accommodate wear and tear on all the moving/pivoting components without readjustments by a trained individual. The design described may be a very costly one and may require a significant amount of space for installation. One may envision that an instrument with such a clamping device may be very large, possibly making it impractical for use in most labs.

PCT Publication No. WO 01/32934 describes a clamping device comprising a fabricated carrier top, two hook/latch pin assemblies and rotatable levers. The clamping mechanism may clamp six (6) individual slides at one time between a long carrier base and carrier top. This design cannot not provide uniform clamping forces across all the slides. Additionally, too much or too little rotation of the levers may affect the force applied to the slides. Too much force may lead to broken slides and too little force may affect total reagent volume in the individual chambers above each slide. With this design all six slide locations require a glass slide to be inserted in order for the clamp to operate as intended. This means that “dummy” slides need to be used in all unused slide positions.

PCT Publication No. WO 01/04634 describes a clamping concept used in an antigen retrieval and/or staining apparatus. The clamping device incorporates a slide support element with a hinge pin mounted on one end. The slide support element is rotated upward to seal the slide to the chamber and downward for removal of the slide. The description may not mention how the slide support element may be secured in place once it is rotated upward. Additionally, the single hinge pin design may cause the end of the slide closest to the hinge pin to contact the chamber first. This can lead to higher stresses at the slide end closest to the hinge pin and possibly to broken slides if the stresses become too high. With this type of design it may be difficult to accurately control the volume of reagent in the chamber thus possibly requiring excess reagent to ensure the chamber is completely full.

U.S. Pat. No. 5,830,413 to Lange et al., describes a clamping mechanism utilizing a spring loaded contact pressure plate and compression springs to seal a glass slide against a support surface. This design utilizes the pressure plate to distribute the clamping forces more uniformly across the slide. The design of the pressure plate makes it moveable for easier slide insertion and removal as compared to the design in U.S. Pat. Nos. 5,695,942 and 5,965,454 to Farmilo. In the Farmilo patents the slide is acted upon by the force of the leaf springs during the entire travel in and out of the assembly. The slide may not be inserted/removed without the springs pushing against the slide. There may be several issues with the clamp described in U.S. Pat. No. 5,830,413 to Lange. The pressure plate has cutouts for the spring to engage to remove the load from the glass slide. The design illustrates the use of multiple springs with balls at the exposed spring ends. The balls engage the cutouts as the pressure plate is lifted thus allowing the spring to expand removing the clamp load from the glass slide. When the pressure plate cutouts engage the spring loaded balls, the spring load may be instantaneously removed from the glass slide. This action may produce a shock wave propagating through the pressure plate and into the glass slide and biological specimen. To apply the clamp load, the user pushes down on the pressure plate with enough force to overcome the friction of the spring loaded ball in the cutout, and the force developed by compressing spring may be at a 90 degree angle to the motion of the pressure plate. This design may also experience the same 10%-15% variance in spring rate as the previously discussed patents. If the user tries to install a glass slide in a clamp that is not fully disengaged there may be a possibility of a broken slide.

U.S. Pat. Nos. 5,364,790 and 5,681,741, both issued to Atwood et al., describe a device that uses a cross beam member, two rigid side clips and a rigid seal ring to secure and seal a cover over a biological specimen attached to a glass microscope slide. The two clips and cross beam member may be removable and can be located anywhere along the length of the slide depending where the biological specimen is attached. The cover has an integral gasket along its perimeter which seals the cover to the glass slide. The two slide clips slide on an inclined surface to apply substantial clamping force to the cover and slide.

The disadvantages of the past inventions may include the following: multiple small parts that may need to be assembled with the aid of custom fixturing by a user; not very ergonomic; may require assembly off the instrument and a second step of loading the assembly into an instrument; and may not be amenable to automated assembly for a totally automated instrument. Since the assembly procedure may be tedious, a potential exists for errors to be made by the user. The cross beam and two slide clips may be formed from rigid materials, most likely stainless steel or similar material. Manufacturing tolerances of these components and the fixturing components may affect the overall clamping force. There appears to be no method to account for tolerance differences and stack-ups in the design.

U.S. Pat. No. 6,258,593 to Schembri et al., describes another clamping device to secure and seal a cover to a glass slide. The invention uses a rigid cover with an inlet and outlet port and a recessed chamber opposite the ports. The cover is placed over the glass slide with an integral seal mating to the slide. An optional gasket may be placed over the cover. A rigid housing is then be screwed down over the cover compressing the seal between the cover and slide. This may be a simple invention, but it too, may have several disadvantages including: high chamber reagent volume; variability in clamping force (users may over-turn or under-turn the threaded fasteners; may require multiple labor intensive steps to engage the clamping device; may not provide uniform clamp force distribution; requires prior assembly before insertion into an instrument by the user; and requires multiple individual loose parts that need to be assembled by the user.

Covers with integral adhesive layers have been used as an alternative to clamping support chambers with integral elastomeric seals over solid support substrates to form hermetically sealed internal chamber volumes. U.S. Pat. No. 6,037,168 to Brown and U.S. Pat. No. 5,346,672 to Stapleton et al. discuss covers that are adhesively bonded to solid support substrates such as glass microscope slides using pressure sensitive adhesives. The adhesive may be applied directly to the cover. The cover is be then placed over the glass slide with an attached biological specimen. The adhesive bonds to the glass slide forming a sealed chamber over the specimen. The adhesive may form the side walls or a portion of the side walls, and the cover and glass slide may form the top and bottom walls of the internal chamber.

The adhesive serves two purposes. First, it may attach the cover to the support substrate. Second, it can form a fluid tight seal to prevent fluid evaporation or leaking out of the chamber. The covers are typically fabricated from plastic or elastomeric materials but other materials may be used. The covers may also have fluid inlets and outlets to dispense and aspirate fluid to and from the internal chamber.

The adhesively bonded covers have several inherent disadvantages. A user is required to carefully place the cover over the glass slide and press down to bond the cover to the slide. Removal of the bonded cover may be difficult and tedious. A user may be required to carefully remove the cover by either peeling the cover off the slide or use a mechanical tool to disengage the adhesive bond. There may exist a potential for users to damage the biological specimen during cover removal, especially when tools may be used. The uniformity of the adhesive thickness may vary affecting the internal chamber volume. Additionally, the bonded covers do not easily lend themselves to automated insertion or removal in automated instruments.

U.S. Pat. No. 3,375,000 to Seamands et al., U.S. Pat. No. 3,873,079 to Kuss, U.S. Pat. No. 4,168,101 to DiGrande, U.S. Pat. No. 4,817,916 to Rawstron, U.S. Pat. No. 5,316,319 to Suggs, and U.S. Pat. No. 6,142,292 to Patterson, describe various applications which may use disc springs to provide a constant “pre-stress” load to maintain bolt torque, valve sealing, bearing support and flexible mounting for bearing thrust plates. However, they do not describe a unique clamp device to secure and seal a support cover to a solid support substrate.

### II. SUMMARY OF INVENTION

In a first aspect, the invention provides a manually operated clamping means to seal a solid support substrate to a solid support cover creating a uniform environmental chamber above a specimen mounted to the support substrate. The clamping means consists of several components that act as a system to provide a repeatable and uniform clamping load to the substrate and cover. There are key components of the design that provide significant advantages to make the invention novel, including a stack of disc springs and an eccentric camshaft.

The clamp device utilizes a stack of disc springs (also known as Belleville washers) to provide uniform clamping force regardless of the user's physical capabilities for mechanical tolerances in the individual clamp components. This can be accomplished by selecting the appropriate disc spring parameters as shown in FIGS. 9 & 10. These springs have inherent advantages compared to standard compression springs and leaf springs. Referring to FIG. 10, the spring rate has a linear relationship to the spring deflection during the initial deflection stages but then becomes non-linear. Depending on the disc spring parameters, the spring force tends to level off with increased spring deflection. Compression springs typically have a linear relationship between spring force and deflection throughout the deflection range making it impractical for use the current invention. Non-repeatable force values may lead to varying internal chamber volumes, broken slides or inadequately sealed chambers. Further, the disc spring(s) may have a height to thickness ratio (h/s) between about 1.3 to about 1.7, to provide and maintain the proper clamping force.

The disc springs may not directly contact the support substrate or the support cover. Instead, the springs may “push” against a heater base/stem and base. Both the heater base/stem and the base may be sufficiently rigid to prevent significant bending under the forces developed by the clamping device. Minimizing the bending of the heater base/stem may provide more uniform clamping pressure to the substrate and cover. The more uniformity of the clamping pressure the less likely support substrates will break when clamped.

The primary function of the eccentric camshaft is to engage or disengage the clamp device. When the lever, which is attached to the camshaft, is rotated counter clockwise (“ccw”), the camshaft rotates counter clockwise and the flat surface in the cam disengages from the flat surface in the cutout. At this point the disc springs is released and raises the heater base/stem. The flat surface in the cutout then follows the contour of the cam surface allowing the heater base/stem to rise due to force of the disc springs.

An insulator is be attached to the top surface of the heater base/stem. A heater plate assembly consisting of metallic plates, a resistive foil heater (or similar heating device), and a temperature sensor is attached to the insulator. The substrate with the biological specimen is placed on top of the heater plate assembly. The heater plate assembly is used to increase the temperature of the substrate and biological specimen from about ambient temperature (15° C.-25° C.) to any temperature up to about 100° C. and may hold it to within about 1.5° C. for a predetermined period of time (i.e., 2 minutes up to about 48 hours or more if required).

A solid support cover with an integral seal is positioned apposed to the top of the substrate forming a sealed chamber over the biological specimen. The sealed chamber volume may vary from about 20 μL to about 200 μL by changing the design of the support cover. The support cover may consist of an inlet and outlet port to add and remove fluids from inside the chamber. To prevent the evaporation, the ports can be sealed either manually with push-in or thread-on seals or they may be sealed with internally mounted seals or valves inside the support cover ports.

As the heater base/stem, insulator, heater plate assembly, substrate and cover rise, the cover top surface contact a compliant material such as a flat silicone gasket attached to two latches. The gaskets provide compliance to account for misalignments, non-parallel and non-flat surfaces while allowing the clamping pressure to be uniformly distributed. The latches may be rotatably mounted to the base and may be manually closed over the cover prior to clamp engagement. However, one skilled in the art may also envision the use of latches that slide in and out either by manual activation or by an automated means.

The lever attached to the end of the camshaft is designed to allow a user to apply a moment of approximately 5-20 lb-in to rotate the camshaft from the engaged clamp position to the disengaged clamp position. The applied moment may be well within the capabilities of operators using the device.

By more accurately controlling the total applied force, the uniformity and repeatability of the applied force through the clamp device design and not through costly part fabrication and assembly, the clamp device becomes novel with several inherent benefits. These benefits may include: prevents broken support substrates (glass slides, silicon slides etc); creates a uniform environmental chamber above specimens mounted to support substrates; achieves repeatable internal chamber volumes, which may be critical when operating in the microfluidics (μL) domain; provides uniform chamber heights above the biological specimen on the support substrate, which helps to achieve controlled processing; minimizes variation from one clamp device to another; eliminates user variability; and provides sufficient compression to form a sealed chamber above the biological specimen, even at elevated temperatures.

The clamping device may act from below the substrate keeping the top of the cover accessible. This feature allows easier access for manual or more importantly automated addition/removal of fluids from the chamber through access ports in the cover. The desire for increased uniformity and repeatability in laboratory testing are just two of many factors driving the need for more automated sample processing. The proposed clamping device may easily interface with automated fluidic handling devices thereby achieving a totally automated system for adding and removing fluids to and from the chamber.

Additionally, the proposed device provides unimpaired viewing of the specimen during processing through a transparent cover. There may be times when a user wants to check the status of a critical test just to be sure it is progressing as expected. The unimpaired viewing is also effective for research applications where users are investigating new procedures, protocols or reagents and want to view the test in real time.

One of the major advantages of the proposed invention is its ease of use. The clamp device was designed for ergonomical use. The latches are simple to grasp and close with one hand. They may open automatically during clamp disengagement. The lever shape can be designed for ease of grasping with a thumb and index finger. The length of the lever is designed to minimize the applied moment, approximately 5-20 lb-in, to disengage the clamp. The clamp device provides easy registration for both the support cover and the support substrate with locating features built into the insulator, the latches and the support cover. The locating features will help to minimize the potential for improper use.

Individual component materials may be selected not only for their mechanical properties but may be also for their chemical compatibility (corrosion properties and chemical attack). Once installed the clamp device may require only minor cleaning of spilled fluids. There may be no adjustments to be made with extended use.

The clamp device can be used in IHC, ISH/FISH, and microarray protocols. The various protocols may call for incubating temperatures ranging from ambient temperature (15° C.-25° C.) up to 100° C. or more. At elevated temperatures, the internal pressure inside the sealed chamber will increase due to volumetric expansion of the reagent/fluid. The increased pressure can be significant. Water, for example, may expand by approximately 4% when heated from 25° C. to 95° C. The total volumetric increase may vary due to reagent properties, surrounding material properties (of the clamp components, substrate and cover) and mechanical compliance in the system.

To reach and hold elevated temperatures, the cover and substrate need to be sealed tightly and be leak free, otherwise fluid will evaporate causing drying out of the biological specimen. The clamp force needs to be sufficiently high to maintain the chamber seal integrity at elevated temperatures (up to 100° C. or more). The proposed clamp device invention may provide approximately 55 lbs. of clamp force. However, this value can be changed by altering the design slightly (i.e., final height of the disc spring stack, size of the disc springs and geometry of the disc spring placement (parallel, series or combination parallel and series). Increasing the temperature to 95° C. may cause internal stresses in the support substrate, which can exacerbate the problem of broken substrates. Uniformly applied clamping loads become critical at elevated temperatures in order to minimize internal stresses in the substrate. Non-uniform loading may not break the substrate during clamp engagement, but as the temperature rises the additional internal stress may surpass the substrate material's stress limit causing the substrate to break.

In one embodiment, the proposed invention may automate the clamp actuation. It can be envisioned that a robotic device (s) inserts the support substrate on to the heater plate and then inserts the support cover over the substrate. It can also be envisioned that a powered actuator (i.e. motor/gripper, piston etc) may close the latches and a second actuator may rotate the lever or camshaft to engage or disengage the clamp device. It can also assumed that the lever may be of different design for use with automated actuation. In fact the lever may even be eliminated and the actuator acts directly on the camshaft.

Another embodiment of the invention may use a single clamping device to secure and seal a single support cover with two or more individual integral seals to two or more support substrates. Each support substrate could have its own dedicated chamber formed by the individual seal and the support cover. The novelty may be a significant reduction in the number of components resulting in lower costs and smaller instruments. Similar clamp components could be used, but they may differ in size to accommodate the larger cover and higher number of support substrates. Rigidity may become more of a concern when clamping multiple substrates to a single cover with a single clamp device. The further away the slides are from the clamping center axis (axis along spring stack), the larger the cantilever and the more likely bending will occur affecting overall clamp force. One way to increase the overall rigidity is to increase the thickness of key components such as the heater base/stem. Automated clamp actuation and substrate and cover insertion may become increasingly practical for totally automated instruments for IHC, ISH/FISH or special stains using small volumes of reagents (i.e. 10-200 μL). Total automation can free the user to perform other tasks while the instrument is operating.

### III. BRIEF DESCRIPTION OF THE DRAWINGS

FIG. 1 shows an embodiment of the invention that is an isometric view of the clamp device in a disengaged position with the support cover and support substrate inserted.

FIG. 2 shows an embodiment of the invention that is a front view of the clamp device in the disengaged position.

FIG. 3 shows an embodiment of the invention that is a cross-sectional view down the center of the clamp device as viewed from the left side with the clamp in a disengaged position.

FIG. 4 shows an embodiment of the invention that is a front view of the clamp device in the engaged position.

FIG. 5 shows an embodiment of the invention that is a cross-sectional view down the center of the clamp as viewed from the left side with the clamp in an engaged position.

FIG. 6a shows an embodiment of the invention that is an isometric view of the eccentric camshaft.

FIG. 6b shows an embodiment of the invention that is a side view of the eccentric camshaft.

FIG. 6c shows an embodiment of the invention that is a front view of the eccentric camshaft.

FIG. 7 shows an embodiment of the invention that is an isometric view of the heater plate assembly.

FIG. 8 shows an embodiment of the invention that is an isometric view of the heater base/stem.

FIG. 9 shows an embodiment of the invention that is a chart illustrating a general comparison of compression springs and disc spring force versus deflection.

FIG. 10 shows an embodiment of the invention that is a chart showing force versus deflection for various disc springs.

### IV. DETAILED DESCRIPTION OF THE PREFERRED EMBODIMENTS

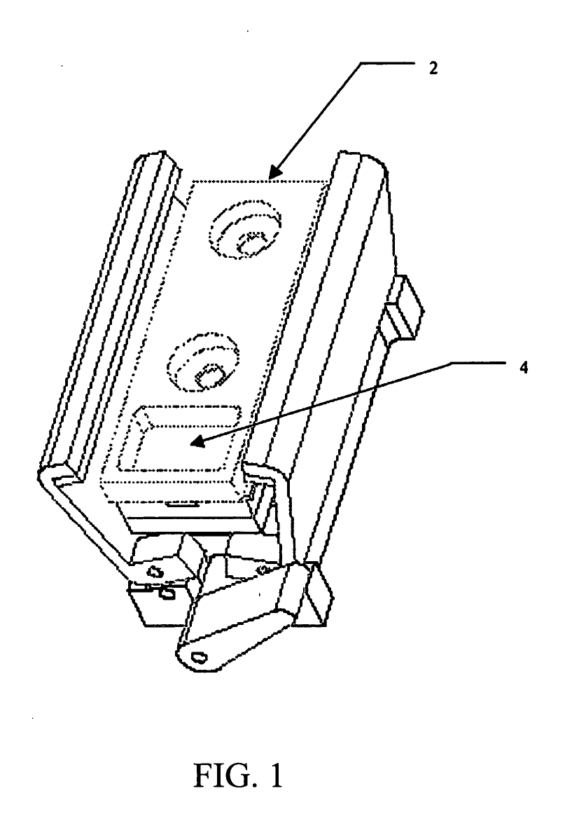

As can be understood from the discussion, the present invention may be embodied in a variety of ways. Although discussed in the context of a particular initial design, it should be understood that the various elements can be altered and even replaced or omitted to permit other designs and functionality as appropriate. Referring to the FIG. 1, it can be seen that in one sense the invention involves a novel clamping device for use with solid support substrates (4) and solid support cover (2) which may be used in IHC, ISH/FISH, DNA microarray, protein array, tissue array staining, special stains and the like.

FIG. 1 is an isometric view of the of one embodiment of the clamp device. The assembly includes the solid support cover (2) and the solid support substrate (4). The substrate illustrated may be a glass microscope slide, which may be 1 inch×3 inches or it may a similar material such as silicon of like dimensions. The clamp device shown is in the disengaged position. The two latches are in the open position.

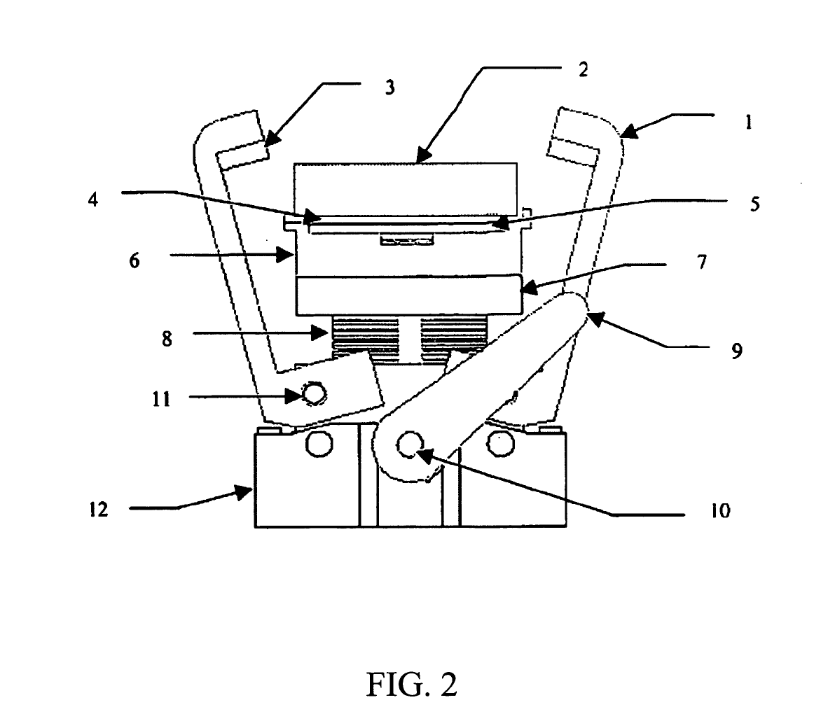

FIG. 2 shows a front view of the clamp device. The device utilizes an eccentric camshaft (10) to release a stack of disc springs (8) and to provide uniform clamping force on the support substrate (4) and support cover (2). The base (12) provides the necessary attachment points, bearing location holes and reactionary force for the disc springs (8). Ten coaxial disc springs (8) are placed over the heater base/stem (7). The quantity, spring parameters and stacking geometry (parallel, series or both) can be varied to achieve different clamping force levels. FIG. 2 illustrates the ten disc springs in a combination of series and parallel stackups to achieve the desired clamp travel and force level. The disc springs (8) determine the applied clamping force of the cover (2) to the substrate (4). The user cannot not determine the clamping force unless components are physically altered, changed or added to the assembly. The force is predetermined by the number of springs, the spring parameters, the geometry of the spring stacking and by the amount of “prestress” in the spring stack (8) in the engaged clamp position. The heater base/stem has a cylindrical shaft on one side which can be used to guide the springs (8).

The clamp device uses a stack of disc springs (8) (also known as Belleville washers) to provide the necessary clamping force. Depending on the disc spring parameters, the spring force may tend to level off with increased spring deflection. Compression springs typically have a linear relationship between spring force and deflection throughout the entire deflection range, possibly making it impractical for use with the current invention. Small changes in compression spring deflection caused by dimensional differences between clamp components, substrates or covers may result in large force changes. Non-repeatable force values can lead to varying internal chamber volumes, air bubbles, broken slides or inadequately sealed chambers.

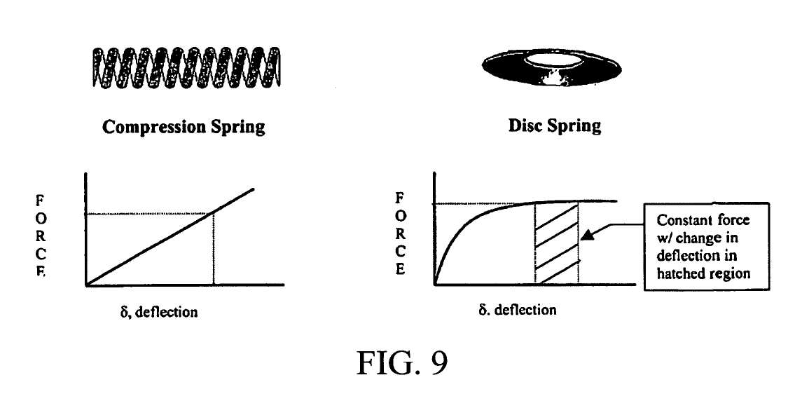

Disc springs with a flat or near flat force level over a given deflection range allow the clamp device to accommodate larger dimensional tolerance variations in clamp components, substrate and cover thickness without adversely effecting the total force level. The proposed invention may also have an additional benefit in that slight wearing of components may not effect the total force level. Additionally, the near flat force level may not significantly increase the required force to disengage the clamp so long as the design operate in the hatched region shown in FIG. 9. Compression springs may require a significant increase in the force required to disengage a clamp by their very design, which follows the linear relation of:
Force=K×Deflection, where K is the spring rate.
This increased force may need to be applied by the operator of the clamp.

According to manufacturers' specification, the spring rate of compression springs and leaf springs may vary from 10%-15% from spring to spring. This potential variation may make it difficult to provide repeatable clamping pressure from one clamp to another. Disc springs on the other hand have a significantly tighter tolerance on the spring rate which may result in highly repeatable clamping forces between different clamp devices.

Disc springs have a significantly better height to force ratio compared to other compression springs or leaf springs. This is critical for maintaining small clamp packages especially when multiple clamp devices are installed in an instrument. Stacked disc springs allow for very compact clamp devices. The disc springs can be fully flattened without adversely affecting the spring force values. There is a limit on the number of cycles for fully compressing the disc springs, but the limit tends to be very high, on the order of 2 million cycles. Compression springs have a deflection operating range of 50%-75% of the free length. Designs that need additional deflection may require springs with longer free lengths or springs with different characteristics (i.e., wire diameter, material or inside/outside diameters). This may be one of the main reasons why the use of compression springs makes assemblies taller. The longer compression spring lengths become, the more they may be likely to buckle affecting total applied force. To prevent buckling, guides may be added, but this may add cost and may require additional space.

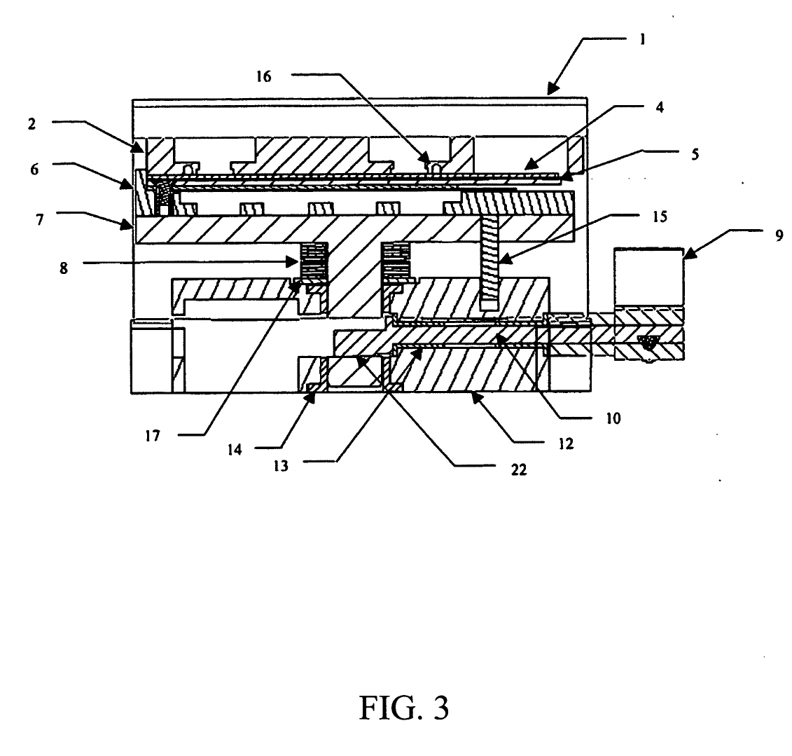

A compliant gasket-like material such as silicone rubber (3) attached to the latches (1) may be used as a means of compliance during clamping to account for tolerance variations in the different system components. The gasket (3) may also permit the clamp device to maintain uniform force distribution along the long edges of the support cover (2) and directly over the seal (16) as shown in FIG. 3. The gasket (3) may be fabricated from elastomers such as silicone rubber, EPDM, or similar materials.

Two latches (1) may pivot on dowel pins (11) which may be press-fit into the base (12). The latches (1), when closed, provide a “stop” (or reaction force) for the support cover (2) as the support cover (2) travels upward during clamp engagement. When the camshaft (10) is rotated to disengage the clamp, the latches (1) automatically rotate open, and allow the user access to both the support cover (2) and support substrate (4). The design utilizes the center of gravity of the latch (1), being off-center from the pivots (11), that allow the latches to rotate open under their own weight. However, an alternative design may also be developed using springs to open the latches. The springs (not shown) can be located in counter bores (not shown) in the base (12).

The latches (1) open 10-15 degrees, each at which point they hit a hardstop machined, attached or molded into the base (12) and prevent further rotation. Latch rotation may be minimized to permit tight spacing between adjacent clamp devices, and thus may minimize the overall footprint of an instrument, while it maximizing the number of support substrates (4) to be loaded for one instrument run.

If for some reason a user inserts a support substrate and support cover on the heater plate with the camshaft in the engaged clamp position, the user will be able to close the latches over the cover. This will prevent accidental slide breakage due to improper operation of the device. This may be another inherent benefit of the proposed invention.

In some embodiments, the present invention may provide a disc spring-loaded mechanism that “pushes” up from below the solid support substrate and not from the top. In another embodiment, the present invention may allow easy manual or robotic access to add or remove fluids from the internal chamber through access ports in the cover. This may also allow unimpaired viewing of the sample through a transparent cover during processing.

FIG. 3 is a cross-sectional view of the clamp device in the disengaged position. Two solid bearings (14) are pressed into the base (12) to provide guidance and a low friction mating surface for the heater base/stem (7) as it travels from the engaged to disengaged positions and vice versa. The heater base/stem has a precision machined stem diameter to also prevent “binding” or “cocking” during clamp operation. Tight tolerances on these components allow the maximum applied clamping force to be realized. Solid bearings are used in the initial prototypes for simplicity, however, more costly ball bushing bearings could be used to reduce the friction further. Initial testing indicated the ball bushings may not be required to meet the design goals. The bearings (14) should be co-located so as to minimize/prevent “cocking” of the heater base/stem (7) during clamp actuation. Two bearings (13) are pressed into the base (12) to provide support, guidance and low friction mating surface to minimize the rotational torque for the eccentric camshaft (10). The bearings used in the prototype are fabricated from solid material, but one skilled in the art can appreciate that other types of bearings may be used as well. A hard washer (17) is placed on top of the heater stem bearing (14) to provide a hard wear surface for the bottom disc spring (8) to slide on during spring compression and expansion so the disc spring does not “dig” into the softer base material or bearing material.

The base (12) can be fabricated from a variety of materials such as aluminum, stainless steel, Delrin, brass, etc. The material may need to be chemically compatible with the reagents and fluids used with ISH/FISH, IHC, special stains, and the like. Each of the materials described previously may have their own advantages. Stainless steel may be very rigid and may provide a hard wear surface for the disc springs to slide on during clamp operation. However, stainless steel also has higher associated machining costs and the material requires the use of bearings (13, 14) for the camshaft (10) and heater base/stem (7) to rotate/slide on. Aluminum may be less costly to machine than stainless steel and is significantly lighter. It too may require the use of bearings. However, since the aluminum is a soft metal, a hard washer (17) is required for the lower disc spring to slide on. The hard washer prevents wear on the aluminum surface. Aluminum particulates can become entrapped in the bearings and may cause binding of the camshaft or heater base/stem. Additionally, wear can become significant with time and may ultimately affect the total applied clamping force.

Materials such as Delrin may have the advantage of reduced machining costs, but also may eliminate the need for bearings. The base can be machined to include “built-in” bearing surfaces thus reducing overall part count and assembly costs. The Delrin base is significantly lighter than its metallic counterparts reducing the overall weight of multiple clamp devices used in instruments. If the clamp devices are mounted on moving platforms, this weight reduction can translate directly to reduced motor requirements since the required energy to move the platforms will be less.

The use of a plastic base material may make it possible to injection mold the part for significant cost reductions. This may have inherent cost advantages for instruments with multiple clamp devices.

An anti-rotation pin (15) is located into the underside of the heater base (7). The pin rides in a closely toleranced hole in the base (12) to prevent angular rotation of the heater base/stem assembly. Movement (angular or translational) may adversely effect the location of the solid support substrate (4) and solid support cover (2). When the clamp device is used with an automated fluid delivery system that deposits/removes fluids through ports in the support cover location of mating, components becomes very critical.

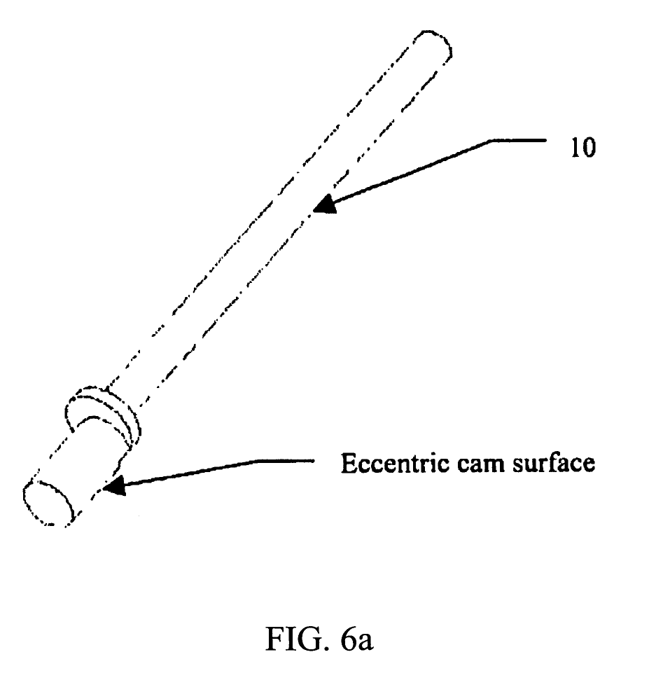

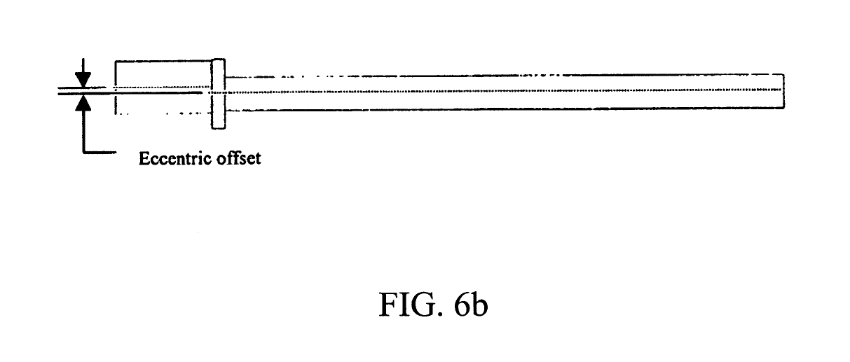

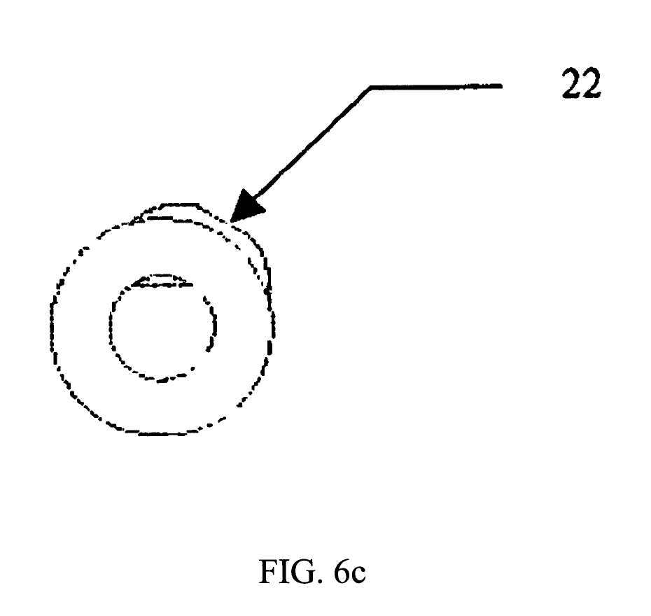

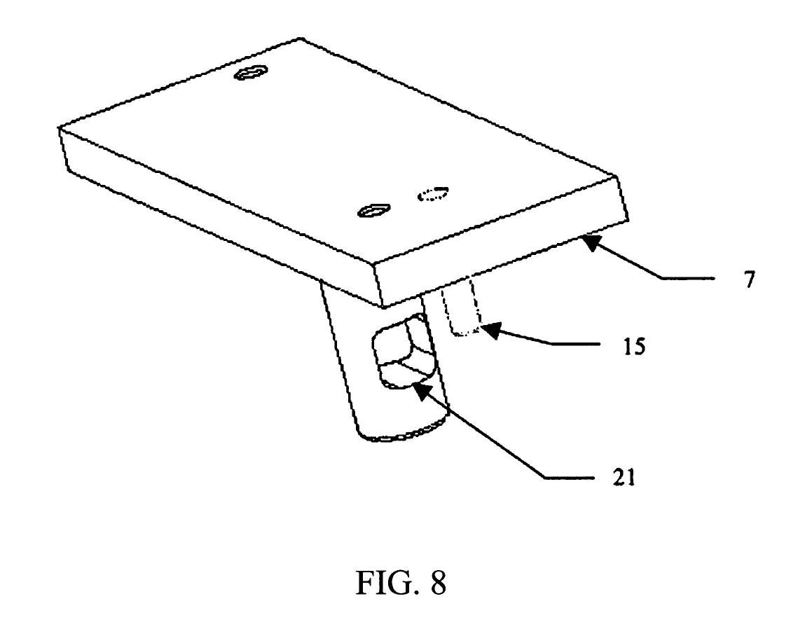

The heater base/stem assembly (7, 8, 15) may be inserted into the bearings (14) until the eccentric cam (10) can be inserted through the base (12), bearings (13) and into a cutout (21) in the heater stem (7). FIG. 8 illustrates the cutout (21) in the heater stem (7). The eccentric cam surface may have a flat (22) machined on it as shown in FIG. 6c. The heater base/stem (7) may have a precision machined stem diameter which can prevent “binding” or “cocking” during clamp operation. Tight tolerances on these components allows the maximum applied clamping force to be realized. Solid bearings were used in the initial prototypes for simplicity, however, more costly ball bushing bearings could be used to reduce the friction further. However, subsequent testing indicated that the ball bushings may not be required to meet the design goals.

A lever (9) with a high precision “D” shaped or other shaped cutout to match the end of the camshaft (10) fits over the exposed cam shaft end. The lever may fit tightly over the camshaft. The “D” or other shaped design prevents the lever from slipping significantly on the camshaft during rotation. A dogpoint set screw (not shown for clarity) may be threaded into a hole in the lever (9). The dog point end fits into a counter bore machined into the camshaft (10) and to provide another level of anti-rotation of the lever (9) on the camshaft (10).

In one embodiment of the clamping device a clockwise (cw) rotation of the lever (9) disengages the clamp, whereas a counter clockwise (ccw) rotation of the lever (9) engages the clamp by releasing the disc spring stack (8). The design of the eccentric camshaft, bearings, and lever may be such that the moment required to disengage the clamp may be about 5-20 lb-in. 5-20 lb-in moment may be well within the capabilities of the operators using the device. The force to rotate the lever can be changed by increasing or decreasing the lever length. Increasing the lever length may reduce the amount of force required to rotate the camshaft. As the lever (9) rotates to the disengaged position the camshaft (10) rotates and the cam surface follows the rotation but on a different arc. When the disengaged position is reached, the flat in the cam surface mates with the bottom flat in the heater stem cutout (21). The flats provide the user with a “positive” feel when the clamp is in the disengaged position and the flats hold the clamp in the this position.

An insulator (6) fabricated from a non-heat conducting material such as Delrin may be attached to the top surface of the heater base (7) with threaded fasteners (not shown for clarity). The insulator (6) reduces the heat conducted away from the bottom side of the heater plate (5) which ensures that the majority of the heat generated conducts to the solid support substrate (4). This allows for rapid temperature rise of the biological specimen.

A heater plate assembly (5) can be employed to provide the necessary heat to raise the substrate (4) temperature from ambient temperature (15° C.-25° C.) to any value up to about 100° C. or even higher if required.

The substrate (4) with the biological specimen is placed on top of the heater plate assembly (5). The heater plate assembly can increase the temperature of the substrate and biological specimen from ambient temperature (15° C.-25° C.) to about 100° C. (or higher) and may hold it to within about 1.5° C. for up to about 48 hours or more if required.

A solid support cover (2) with an integral seal (16) is placed apposed to the top of the substrate (4) forming a sealed chamber over the biological specimen. The sealed chamber volume can vary from about 20 μL to about 200 μL by changing the design of the support cover (2). Typically, the support cover may be fabricated from molded or machined plastics such as Perspex, polycarbonate, polysulfone, glass, silicon or similar materials. The integral seal (164) can be made from elastomers such as silicone rubber, EPDM, Kalrez or similar materials. The cross-sectional geometry of the seal can be rectangular, square, circular, oval, or the like in shape. Additionally, the seal can be a separate molded part that is inserted into a groove in the cover (2). The support cover (2) may consist of an inlet and outlet port to add and remove fluids from the inside the chamber. To prevent evaporation, the ports can be sealed either manually with push-in plugs, thread-on seals, or the like. The ports may be sealed with internally mounted seals or valves inside the support cover ports.

Generally, the cover may form a controlled environmental volume above the biological specimen when it is engaged by the clamp mechanism to the support substrate. The clamp device provides a uniform and repeatable clamping force each time it is engaged, thereby establishing a repeatable, controlled height of the cover above the support substrate which may establish a repeatable, controlled volume above the biological specimen for performing in-situ hybridization, fluorescent in-situ hybridization or similar analyses using low fluid volumes on the order of about 10 μL to about 200 μL. Further, along with using a biological specimen, the controlled environment may also be used when performing an analysis on a substrate, such as but limiting to, an array. There may be several different arrays used with embodiments of the present invention, including DNA, RNA, cDNA, oligonucleotides, and peptide arrays. The clamp device provides the uniform and repeatable clamping force by means of a single or combination of multiple disc springs that are actuated by a rotatable camshaft. The final clamping force is directly related to the compression of the disc spring(s) and not by the user of the device. User variability is removed by the incorporation of the camshaft actuator to release the preloaded disc springs.

As the lever (9) rotates counter clockwise, the heater base/stem (7), insulator (6), heater plate assembly (5), substrate (4) and cover (2) rise, the cover top surface contacts a compliant gasket-like material (3) attached to the two latches (1). The cover (2) compresses the gasket-like material (3) during clamp engagement. The gasket-like material (3) provides compliance to account for misalignments, non-parallel and non-flat surfaces while allowing the clamping pressure to be uniformly distributed. The latches (1) may be rotatably mounted to the base (12) and may be manually closed over the cover (2) prior to clamp engagement. The latches may also be designed to close automatically. The latches may be made from a rigid material such as aluminum, fiber reinforced plastics, or the like which may prevent/reduce bending from the applied clamp force.

At a predetermined point in its rotation, the cam surface disengages from the heater base/stem (7). The lever (9) attached to the camshaft (10) may move freely (approximately 30°-45°) at this point signaling that the clamp is fully engaged. Disengagement of the cam from the heater base/stem allows the full load of the clamp device to be applied to the heater base/stem (7) and into the support substrate (4) and cover (2). The clamp device may not use a “positive” stop for the engaged clamp position purposely. As one skilled in the art knows there may be part to part dimensional variations which may add up to significant tolerance stack-up differences. A “positive” stop for lever rotation could allow the clamp force to deviate significantly from the intended design goal. The cam may actually “hold” the clamp back resulting in decreased force or it may allow the user to apply more force than may be required causing substrates to break. The cam design in the proposed invention overcomes these issues by, in one embodiment, totally disengaging from the heater base/stem which allows only the stack of disc springs (8) to determine the final applied load.

By changing the design slightly, one skilled in the art can vary the force required to disengage the clamp.

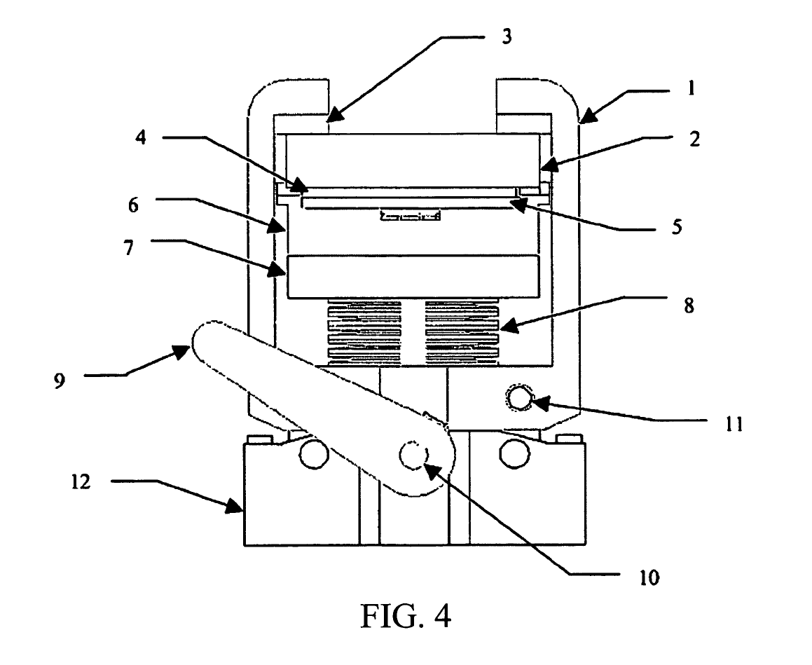

FIG. 4 depicts the clamp device in the engaged position. The lever (9) has been rotated counter clockwise and the entire assembly above the disc springs (8) has traveled upward until the support cover (2) stopped against the compliant gasket-like material (3). The latch (1) provides a rigid backing for the gasket-like material (3). This view also illustrates the open area above the cover (2) for manual or automated addition/removal of fluids in the chamber through access ports in the cover (not shown). Further, a transparent cover may allow unimpaired viewing from above the solid support substrate.

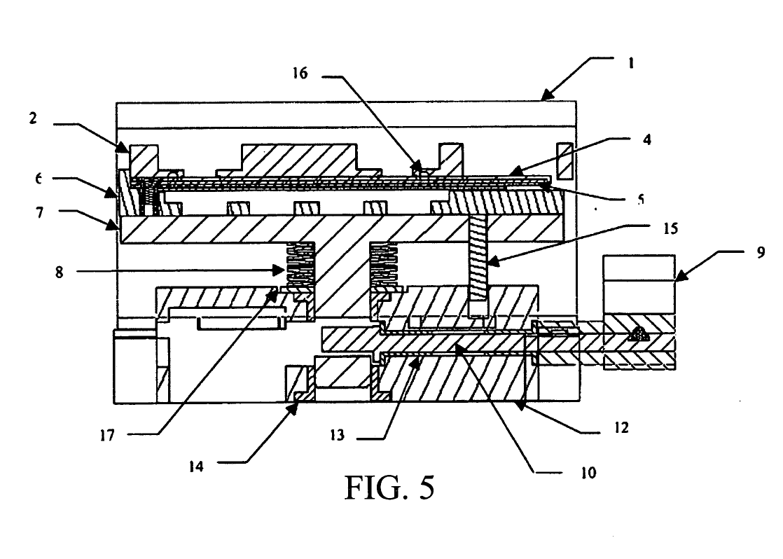

FIG. 5 is a cross-sectional view of the clamp device in the engaged position. When the lever (9) rotates counter clockwise, the flat (22) in the eccentric camshaft (10) disengages from the flat in the bottom surface in the heater stem (7) cutout (21). As the camshaft (10) rotates further counter clockwise, the heater stem (7) rises until the support cover (2) top surface comes to rest against the compliant gasket-like material (3). By design, in one embodiment, the eccentric cam disengages completely from the heater stem (7) cut-out (21) surface which ensures the full force of the disc springs (8) are exerted on the support substrate (4) and the support cover (2). The operator has no control over the force/torque application and hence has no influence on the applied clamping force.

FIG. 6 shows the eccentric camshaft (10). The camshaft consist of a straight shaft section and an axially offset cam section. The offset cam section produces an eccentric cam surface which may be used to an advantage in operating the device. A flat (22) is machined into the cam surface. As described previously, the flat (22) mates with a flat in the heater base/stem (7) cutout (21) to provide a “positive” feel when the clamp is fully disengaged and to hold the clamp in this position.

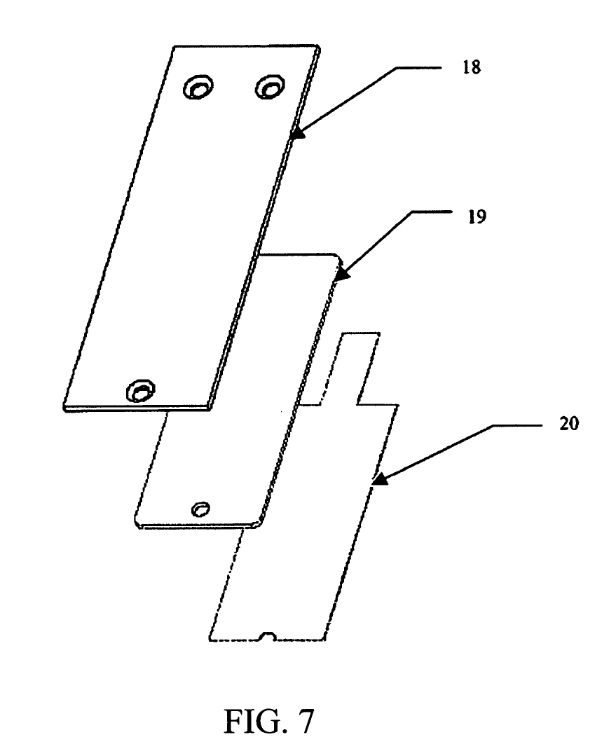

In one embodiment, the heater plate assembly may consist of four components of which three are shown in FIG. 7. The heater plate assembly may consist of more than or less than four components. The heater plate (18) may be fabricated from a metallic material, which may be chemically compatible with the reagents/fluids used in IHC, ISH/FISH, special stains and microarray processing. A highly conductive metallic plate (19) may be attached to the underside of the heater plate (18) which may provide uniform heat distribution across the plate. A resistive heating foil (20), attached to the conductive plate (19), may be used to increase the temperature of the solid support substrate and biological specimen. The temperature range may be from ambient temperature (15° C.-25° C.) to 100° C. or higher depending on the protocol for each biological specimen. A temperature sensor (not shown) such as a thermistor, thermocouple, RTD or similar device may be attached to the underside of the conductive plate (19). The temperature sensor monitors the temperature of the conductive plate, which may be directly related to the temperature of the heater plate and the solid support substrate. The sensor may provide feed back control to an instrument processor.

FIG. 8 is an illustration of the heater base/stem (7). An anti-rotation pin (15) is located in the underside of the heater base/stem (7) to prevent rotation of the support substrate (4) and support cover (2) during clamp engagement and disengagement. The stem portion of the heater base/stem has a cutout (21) through which the camshaft (10) cam surface may rotate. A flat may be machined into the bottom of the cutout (21). The cutout (21) flat may mate with the flat (22) in the cam surface. The stem is a precision machined diameter with close tolerancing allowing it to slide freely in the bearings (14).

FIG. 9 illustrates a general comparison of the force versus deflection between disc springs and compression springs. The force versus deflection curve for the compression springs is linear throughout its deflection whereas only a portion of the disc spring curve may be linear. The disc spring force vs. deflection curve may become more horizontal as the deflection increases depending upon the relationship of the spring height, h, to the spring thickness, s. In a referred embodiment, the clamp device disc spring stack may operate in the flat portion of the curve, by using springs with a height to thickness ratio (h/s) of 1.3 to 1.7, but may be limited to a small region of the flat portion (cross-hatched region).

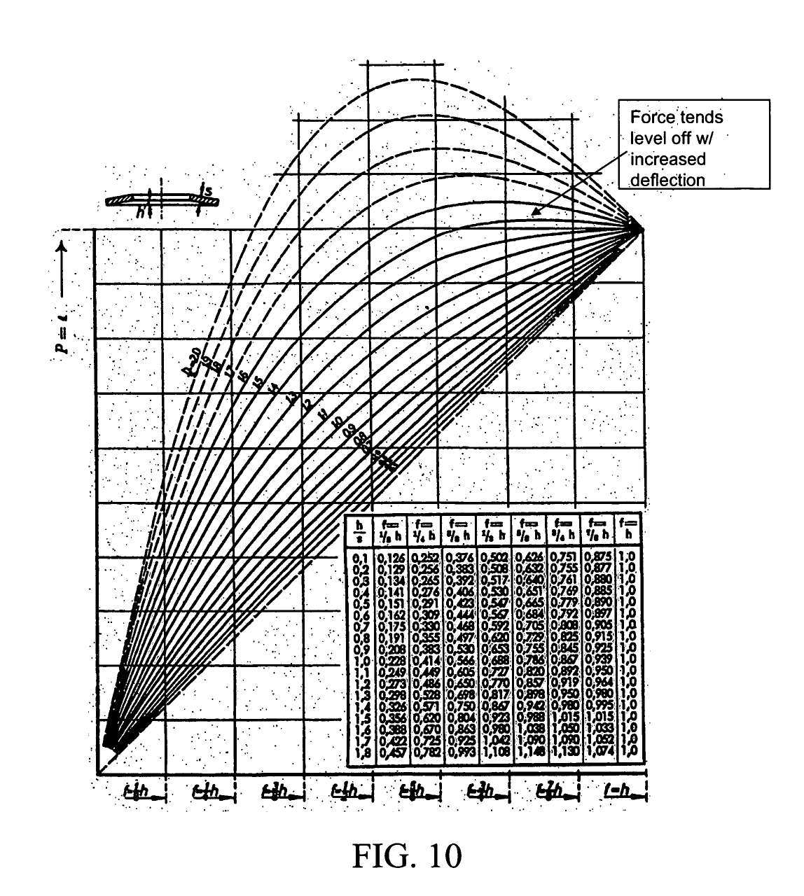

FIG. 10 illustrates a force versus deflection chart for various types of disc springs. In some aspects, the present invention may utilize a disc spring with parameters similar to the one indicated by the arrow in figure. In a preferred embodiment, the clamp device disc spring stack may operate in the flat portion of the curve, by using springs with a height to thickness ratio (h/s) of 1.3 to 1.7, but may be limited to a small region of the flat portion (cross-hatched region).

Once the clamp device is assembled, it may be ready to use either as a stand-alone unit or to be incorporated into an instrument. First, the lever (9) is rotated to disengage the clamp. A solid support substrate (4) with a biological specimen attached is placed onto the heater plate (5). This step may be performed manually by the user, but it can also be envisioned to be performed automatically by a robotic device. The support substrate (4) may be located by features fabricated in the insulator (6). Next a solid support cover (2) with an integral seal (16) is placed over the support substrate and can also be located by the features in the insulator (6). The latches (1) are “squeezed” closed with a user's hand, and the lever (9) is rotated counter clock wise with the user's other hand to engage the clamp, which seals the support cover (2) to the support substrate (4). A sealed microchamber is formed between the support chamber (2) and the support substrate (4) with the seal (16) forming the vertical walls.

After processing the biological specimen, the lever (9) may be rotated clockwise until the user may feel the “positive” stop of the eccentric camshaft flat (10) engaging the flat in the heater stem (7) cutout (21). As the lever (9) rotates, the heater base/stem (7) with the support substrate (4) and the support cover (2) travels downward, and the latches (1) automatically open when the support cover (2) disengages the compliant gasket (3). Now the support cover (2) and the support substrate (4) may be easily removed by the operator.

One embodiment of the invention may add a thin, low friction material to the exposed flat surface of the gasket-like material to prevent the support cover from adhering to the gasket-like material. This add material may be bonded to the gasket-like material or it may be fabricated into the gasket-like material. The low friction material needs to be thin in order to allow compliance when engaged with the support cover.

Other embodiments of the invention may be further described by citing examples of ISH, FISH, DNA micorarray and IHC protocols that can be processed using an instrument incorporating the novel clamping device. It is understood that these examples are intended to be illustrative only and do not limit the invention in any way.

### EXAMPLE 1—ISH PROTOCOL

A biological specimen (tissue sample) is fixed in formalin and then embedded with paraffin by standard procedures. The embedded tissue is attached to a glass microscope slide. The tissue is then deparaffinized while on the slide by standard deparaffinizing procedures. The glass slide with the attached biological specimen is placed on top of the heater plate. A disposable support cover with an inlet and outlet port and integral seal is placed on top of the glass slide. The latches of the clamp mechanism are closed over the cover and the clamp is engaged by rotating the lever counterclockwise. The cover now makes a sealed chamber (except for the open ports) over the biological specimen on the slide. Reagents and wash buffers are then injected into the chamber through the inlet port in the following order. Each reagent and wash buffer application has its own temperature requirements and incubation times.

| STEP NO. | REAGENT | TEMP. ° C. | TIME | |
|---|---|---|---|---|
| 1 | Proteolytic treatment, 10-200 μL | 37° C. | 30 | minutes |
| 2 | Dehydrate, 70% ethanol | RT | 1 | minute |
| 3 | Dehydrate, 95% ethanol | RT | 1 | minute |
| 4 | Dehydrate, 100% ethanol | RT | 1 | minute |
| 5 | Air dry | | | |
| 6 | Seal inlet/outlet ports | | | |
| 7 | HPV probe solution, 10-200 μL | 95° C. | 5 | minutes |
| 8 | HPV probe solution, 10-200 μL | 37° C. | 16 | hrs. |
| 9 | Remove inlet/outlet port seals | | | |
| 10 | TBS buffer solution, 1-5 mL | 37° C. | 10 | minutes |
| 11 | AP-conjugated anti-biotin (red) | 37° C. | 30 | minutes |
| 12 | TBS buffer, 1-5 mL | RT | 1 | minute |
| 13 | Deionized water, 1-5 mL | RT | 1 | minute |
| 14 | NBT/BCIP (blue) | 37° C. | 10 | minutes |
| 15 | TBS buffer, 1-5 mL | RT | 1 | minute |
| 16 | Deionized water, 1-5 mL | RT | 1 | minute |
| 17 | Nuclear Fast red, 10-200 μL | RT | 1 | minute |
| 18 | Deionized water, 1-5 mL | RT | 1 | minute |

The addition of reagents (10-200 μL) to the chamber can be accomplished manually with a pipettor directly through the inlet port. Air is “pushed” out through the outlet port as the reagent travels across the chamber. The addition of reagents (1-5 mL) can be easily automated with equipment known by one skilled in the art of fluidics. The buffers and water can be “flushed” through the chamber or they can incubate in the chamber for a period of time. Removal of liquids from the chamber is automated by means of vacuum applied to the outlet port. Air drying is accomplished by pulling a vacuum through the chamber outlet port and drawing heated air through the inlet port.

Alternately, the reagents (10-200 μL) can be added to the chamber (through the inlet port) by automated pipettors or other fluidic devices for a totally automated instrument. Air is “pushed” out through the outlet port as the reagent travels across the chamber. The addition of reagents (1-5 mL) can be easily automated with equipment known by one skilled in the art of fluidics. The buffers and water can be “flushed” through the chamber or they can incubate in the chamber for a period of time. Removal of liquids from the chamber is automated by means of vacuum applied to the outlet port.

Once the protocol is completed the user rotates the lever clockwise to open the clamp. The latches fall open and the user can remove the cover and the slide. The slide is then coverslipped with mounting media.

### EXAMPLE 2—FISH PROTOCOL

A biological specimen (tissue sample) is fixed in formalin and then embedded with paraffin by standard procedures. The embedded tissue is attached to a glass microscope slide. The tissue is then deparaffinized while on the slide by standard deparaffinizing procedures. The glass slide with the attached biological specimen is placed on top of the heater plate. A disposable support cover with an inlet and outlet port and integral seal is placed on top of the glass slide. The latches of the clamp mechanism are closed over the cover and the clamp is engaged by rotating the lever counterclockwise. The cover now makes a sealed chamber (except for the open ports) over the biological specimen on the slide. Reagents and wash buffers are then injected into the chamber through the inlet port in the following order. Each reagent and wash buffer application has its own temperature requirements and incubation times.

| STEP | | | | |
|---|---|---|---|---|
| NO. | REAGENT | TEMP. ° C. | TIME | |
| 1 | Dehydrate, 100% ethanol 1-5 ml | RT | 10 | minutes |
| 2 | Air dry slide | | | |
| 3 | Proteolytic treatment, 10-200 μL | 37° C. | 10 | minutes |
| 4 | Wash w/dH₂O 1-5 ml | RT | 1 | minute |
| 5 | Wash 2X SSC | RT | 2 | minutes |
| 6 | Seal inlet/outlet ports | | | |
| 7 | Probe solution, 10-200 μL | 75° C. | 5 | minutes |
| 8 | Probe solution | 37° C. | 16 | hrs. |
| 9 | Remove port seals | | | |
| 10 | Wash 50% formamide/2X SSC | 45° C. | 5 | minutes |
| 11 | Wash 2X SSC/.1% NP-40 | 45° C. | 4 | minutes |
| 12 | Wash 2X SSC/.1% NP-40 | RT | 4 | minutes |
| 13 | Counterstain w/DAPI, | | | |
| | 10-200 μL | | | |
| 14 | Wash 2X SSC | | 2-4 | minutes |

Once the protocol is completed the user rotates the lever clockwise to open the clamp. The latches fall open and the user can remove the cover and the slide. The slide is then coverslipped with mounting media.

### EXAMPLE 3—DNA MICROARRAY PROTOCOL

A glass slide with the attached DNA microarray is placed on top of the heater plate. A disposable support cover with an inlet and outlet port and integral seal is placed on top of the glass slide. The latches of the clamp mechanism are closed over the cover and the clamp is engaged by rotating the lever counterclockwise. The cover now makes a sealed chamber (except for the open ports) over the microarray on the slide. Reagents and wash buffers are then injected into the chamber through the inlet port in the following order. Each reagent and wash buffer application has its own temperature requirements and incubation times.

| STEP NO. | REAGENT | TEMP. ° C. | TIME | |
|---|---|---|---|---|
| 1 | Prehybridization solution, | 37° C. | 0.5-2 | hrs |
| | 10-200 μL. Seal | | | |
| | inlet/outlet ports | | | |
| 2 | Remove port seals | | | |
| 3 | Wash w/dH₂0 1-5 ml | RT | | |
| 4 | Fluorescent target | 65° C. | 2 | minutes |
| | hybridization solution, | | | |
| | 10-200 μL. | | | |
| | Seal inlet/outlet ports | | | |
| 5 | Target hybridization solution | 37° C. | 16 | hrs. |
| 6 | Remove port seals | | | |
| 7 | Wash .1X SSC w/.1% SDS, | RT | | |
| | 1-5 ml | | | |
| 8 | Wash .1X SSC, 1-5 ml | RT | | |
| 9 | Dry slides | | | |

Once the protocol is completed the user rotates the lever clockwise to open the clamp. The latches fall open and the user can remove the cover and the slide. The slide is then ready for fluorescent imaging.

As can be easily understood from the foregoing, the basic concepts of the present invention may be embodied in a variety of ways. It involves both analysis techniques as well as devices to accomplish the appropriate analysis. In this application, the substrate processing systems are disclosed as part of the results shown to be achieved by the various devices described and as steps that are inherent to utilization. They are simply the natural result of utilizing the devices as intended and described. In addition, while some devices are disclosed, it should be understood that these not only accomplish certain methods but also can be varied in a number of ways. Importantly, as to all of the foregoing, all of these facets should be understood to be encompassed by this disclosure.

The discussion included in this application is intended to serve as a basic description. The reader should be aware that the specific discussion may not explicitly describe all embodiments possible; many alternatives are implicit. It also may not fully explain the generic nature of the invention and may not explicitly show how each feature or element can actually be representative of a broader function or of a great variety of alternative or equivalent elements. Again, these are implicitly included in this disclosure. Where the invention is described in device-oriented terminology, each element of the device implicitly performs a function. Apparatus claims may not only be included form the device described, but also method or process claims may be included to address the functions the invention and each element performs. Neither the description nor the terminology is intended to limit the scope of the claims herein included.

It should also be understood that a variety of changes may be made without departing from the essence of the invention. Such changes are also implicitly included in the description. They still fall within the scope of this invention. A broad disclosure encompassing both the explicit embodiment(s) shown, the great variety of implicit alternative embodiments, and the broad methods or processes and the like are encompassed by this disclosure and may be relied for support of the claims of this application. It should be understood that any such language changes and broad claiming is herein accomplished. This full patent application is designed to support a patent covering numerous aspects of the invention both independently and as an overall system.

Further, each of the various elements of the invention and claims may also be achieved in a variety of manners. This disclosure should be understood to encompass each such variation, be it a variation of an embodiment of any apparatus embodiment, a method or process embodiment, or even merely a variation of any element of these. Particularly, it should be understood that as the disclosure relates to elements of the invention, the words for each element may be expressed by equivalent apparatus terms or method terms—even if only the function or result is the same. Such equivalent, broader, or even more generic terms should be considered to be encompassed in the description of each element or action. Such terms can be substituted where desired to make explicit the implicitly broad coverage to which this invention is entitled. As but one example, it should be understood that all actions may be expressed as a means for taking that action or as an element which causes that action. Similarly, each physical element disclosed should be understood to encompass a disclosure of the action which that physical element facilitates. Regarding this last aspect, as but one example, the disclosure of a “clamp” should be understood to encompass disclosure of the act of “clamping”—whether explicitly discussed or not—and, conversely, were there effectively disclosure of the act of “clamping”, such a disclosure should be understood to encompass disclosure of a “clamp” and even a “means for clamping.” Such changes and alternative terms are to be understood to be explicitly included in the description.

Any patents, publications, or other references mentioned in this application for patent are hereby incorporated by reference. In addition, as to each term used it should be understood that unless its utilization in this application is inconsistent with such interpretation, common dictionary definitions should be understood as incorporated for each term and all definitions, alternative terms, and synonyms such as contained in the Random House Webster's Unabridged Dictionary, second edition are hereby incorporated by reference. Finally, all references listed in the list of References To Be Incorporated By Reference In Accordance With The Patent Application or other information statement filed with the application are hereby appended and hereby incorporated by reference, however, as to each of the above, to the extent that such information or statements incorporated by reference might be considered inconsistent with the patenting of this/these invention(s) such statements are expressly not to be considered as made by the applicant(s).

Thus, the applicant(s) should be understood to claim at least: i) each of the sample processing systems as herein disclosed and described, ii) the related methods disclosed and described, iii) similar, equivalent, and even implicit variations of each of these devices and methods, iv) those alternative designs which accomplish each of the functions shown as are disclosed and described, v) those alternative designs and methods which accomplish each of the functions shown as are implicit to accomplish that which is disclosed and described, vi) each feature, component, and step shown as separate and independent inventions, vii) the applications enhanced by the various systems or components disclosed, viii) the resulting products produced by such systems or components, ix) methods and apparatuses substantially as described hereinbefore and with reference to any of the accompanying examples, and x) the various combinations and permutations of each of the previous elements disclosed.

It should be understood that for practical reasons and so as to avoid adding potentially hundreds of claims, the applicant may eventually present claims with initial dependencies only. Support should be understood to exist to the degree required under new matter laws—including but not limited to European Patent Convention Article 123(2) and United States Patent Law 35 U.S.C 5 132 or other such laws—to permit the addition of any of the various dependencies or other elements presented under one independent claim or concept as dependencies or elements under any other independent claim or concept.

Further, if or when used, the use of the transitional phrase “comprising” is used to maintain the “open-end” claims herein, according to traditional claim interpretation. Thus, unless the context requires otherwise, it should be understood that the term “comprise” or variations such as “comprises” or “comprising”, are intended to imply the inclusion of a stated element or step or group of elements or steps but not the exclusion of any other element or step or group of elements or steps. Such terms should be interpreted in their most expansive form so as to afford the applicant the broadest coverage legally permissible.

The claims set forth in this specification are hereby incorporated by reference as part of this description of the invention, and the applicant expressly reserves the right to use all of or a portion of such incorporated content of such claims as additional description to support any of or all of the claims or any element or component thereof, and the applicant further expressly reserves the right to move any portion of or all of the incorporated content of such claims or any element or component thereof from the description into the claims or vice-versa as necessary to define the matter for which protection is sought by this application or by any subsequent continuation, division, or continuation-in-part application thereof, or to obtain any benefit of, reduction in fees pursuant to, or to comply with the patent laws, rules, or regulations of any country or treaty, and such content incorporated by reference shall survive during the entire pendency of this application including any subsequent continuation, division, or continuation-in-part application thereof or any reissue or extension thereon. Moreover, the applicant does not waive any right to develop further claims based upon the description set forth above as a part of any non-provisional application, or continuation, division, or continuation-in-part thereof, and the claims set forth below are intended to set out a limited number of the preferred embodiments of the invention and are not to be construed as the broadest embodiment of the invention or a complete listing of embodiments of the invention that may be claimed.

What is claimed is:

1. A method for processing a biological specimen comprising the steps of:
a. providing at least one solid support substrate;
b. providing at least one solid cover;
c. providing a compliant seal between said solid cover and said solid support substrate;
d. manually clamping said at least one solid support substrate to said at least one solid cover via said compliant seal between said at least one solid cover and said at least one solid support substrate; and
e. compressing through said step of manually clamping said at least one solid cover and said compliant seal to said at least one solid support substrate in a manner that repeatably achieves a desired environment.

2. A method for processing a biological specimen of claim 1 further comprising the step of establishing fluid volumes of about 10 μL to about 200 μL.

3. A method for processing a biological specimen of claim 1 further comprising the step of establishing a desired height of said at least one solid cover.

4. A method for processing a biological specimen of claim 1 further comprising the step of performing an analysis on said support substrate, said analysis selected from the group consisting of in-situ hybridization and fluorescent in-situ hybridization.

5. A method for processing a biological specimen of claim 1 wherein said step of compressing said solid cover and said compliant seal to said solid support substrate comprises the step of forming a repeatable environmental volume above said biological specimen.

6. A method for processing a biological specimen comprising the steps of:
a. providing at least one solid support substrate;
b. providing at least one solid cover;
c. providing a compliant seal between said solid cover and said solid support substrate; and
d. pushing from below to compress said solid cover and said compliant seal to said solid support substrate.

7. A method for processing a biological specimen comprising the steps of:
a. providing at least one solid support substrate;
b. providing at least one solid cover;
c. providing a compliant seal between said solid cover and said solid support substrate;
d. compressing said solid cover and said compliant seal to said solid support substrate; and
e. establishing an open space above said solid support substrate.

8. A method for processing a biological specimen in claim 7 further comprising the step of establishing unimpaired viewing of said solid support substrate from above said solid support substrate.

9. A method for processing a biological specimen in claim 8 further comprising the step of providing a transparent cover.

10. A method for processing a biological specimen in claim 7 further comprising the step of establishing manual access to add or remove fluids from an internal chamber through at least one port in said solid cover.

11. A method for processing a biological specimen in claim 7 further comprising the step of establishing robotic access to add or remove fluids from an internal chamber through at least one port in said solid cover.

12. A biological specimen processing device comprising:
a. at least one solid support substrate;
b. at least one solid cover placed in contact with said solid support substrate;
c. a seal located between said solid support substrate and said solid cover;
d. an internal chamber defined by said solid support substrate, said solid cover and said seal; and
e. at least one pivot latch.

13. A biological specimen processing device of claim 12 further comprising a camshaft.

14. A biological specimen processing device of claim 12 further comprising an actuated, disc, spring-loaded mechanism.

15. A biological specimen processing device of claim 12 wherein said disc spring-loaded mechanism pushes up from below said solid support substrate allowing unimpaired viewing of said biological specimen through a transparent cover.

16. A biological specimen processing device of claim 12 wherein said disc spring-loaded mechanism pushes up from below said solid support substrate allowing easy manual or robotic access to add or remove fluids from said internal chamber thought at least one port in said solid cover.

17. A biological specimen processing device of claim 13, wherein said camshaft comprises an eccentric cam surface comprising the capability of producing an offset translation during rotation of said camshaft.

18. A biological specimen processing device of claim 14, wherein said disc spring-loaded mechanism comprises a single disc spring to provide a constant uniform clamping force.

19. A biological specimen processing device of claim 14, wherein the spring-loaded mechanism comprises a stack of multiple disc springs placed in a manner selected from the group consisting of series, parallel, and a combination of said series and said parallel to provide a constant uniform clamping force.

20. A biological specimen processing device of claim 12, wherein said seal comprises the cross-sectional geometry selected from the group comprising of a rectangular, square, circular, and oval.

21. A biological specimen processing device of claim 12, wherein said seal comprises an elastomer selected from the group consisting of silicone rubber, EPDM, and Kalrez.

22. A biological specimen processing device of claim 12, wherein said seal comprises an adhesive layer attached to said solid cover to bond said solid cover to said solid support substrate.

23. A biological specimen processing device of claim 12, wherein said solid cover is removable from the said solid support substrate.

24. A biological specimen processing device of claim 12, further comprising a heater assembly, said heater assembly used to heat said solid support substrate from about room temperature to approximately 100° C. or higher.

25. A biological specimen processing device of claim 24, wherein said heater assembly comprises:
a. a heating element attached to a conductive metallic plate(s); and
b. a temperature sensor to measure a metallic plate temperature which is related to temperatures of said solid support substrate and a biological specimen.

26. A biological specimen processing device of claim 24 wherein said heater assembly is attached to an insulator, wherein said insulator maximizes heat flow to said solid support substrate by minimizing indirect or direct heating of components surrounding said solid support substrate.

27. A biological specimen processing device:
a. multiple solid support substrates;
b. a single solid cover placed in contact with said multiple solid support substrates;
c. a seal located between each said multiple solid support substrate and said single solid cover;
d. multiple internal chambers defined by said multiple solid support substrates, said single solid cover and said seal; and
e. at least one pivot latch.

28. A biological specimen processing device of claim 27, wherein said multiple solid support substrates comprises a glass slide.

29. A biological specimen processing device of claim 27, wherein said multiple solid support substrates comprises a silicone slide.

30. A biological specimen processing device of claim 27, further comprising a camshaft.

31. A biological specimen processing device of claim 27, further comprising an actuated, disc, spring-loaded mechanism.

32. A biological specimen processing device of claim 30, wherein said camshaft comprises an eccentric cam surface having the capability of producing an offset translation during rotation of said camshaft.

33. A biological specimen processing device of claim 31, wherein said disc spring-loaded mechanism comprises a single disc spring to provide a constant uniform clamping force.

34. A biological specimen processing device of claim 31, wherein said disc spring-loaded mechanism comprises a stack of multiple disc springs placed in a manner selected from the group consisting of series, parallel, and a combination of said series and said parallel to provide a constant uniform clamping force.

35. A biological specimen processing device of claim 27, wherein said seal comprises the cross-sectional geometry selected from the group comprising of a rectangular, square, circular, and oval.

36. A biological specimen processing device of claim 27, wherein said seal comprises an elastomer selected from the group consisting of silicone rubber, EPDM, and Kalrez.

37. A biological specimen processing device of claim 27, wherein said seal comprises an adhesive layer attached to said solid cover to bond said solid cover to said solid support substrate.

38. A biological specimen processing device of claim 27, wherein said solid cover is removable from the said solid support substrate.

39. A biological specimen processing device of claim 27, further comprising a heater assembly, said heater assembly used to heat said solid support substrate to about room temperature to at least about 95° C.

40. A biological specimen processing device of claim 39, wherein said heater assembly comprises:
a. a heating element attached to a conductive metallic plate(s); and
b. a temperature sensor to measure a metallic plate temperature which is related to temperatures of said solid support substrate and a biological specimen.

41. A biological specimen processing device of claim 39, wherein said heater assembly is attached to an insulator wherein said insulator maximizes heat flow to said solid support substrate by minimizing indirect or direct heating of components surrounding said solid support substrate.

42. An array processing device comprising:
a. at least one solid support substrate;
b. at least one solid cover placed in contact with said solid support substrate;
c. a seal located between said solid support substrate and said solid cover;
d. an internal chamber defined by said solid support substrate, said solid cover and said seal; and
e. at least one pivot latch.

43. An array processing device of claim 42, further comprising an array; wherein said array is selected from the group consisting of DNA, RNA, cDNA, oligonucleotides, tissue arrays, protein arrays and peptide arrays.

44. An array processing device of claim 42, wherein said solid support substrate comprises a glass slide.

45. An array processing device of claim 42, wherein said solid support substrate comprises a silicone slide.

46. An array processing device of claim 42, further comprising a camshaft.

47. An array processing device of claim 42, further comprising an actuated, disc, spring-loaded mechanism.

48. An array processing device of claim 46, wherein said camshaft comprises an eccentric cam surface having the capability of producing an offset translation during rotation of said camshaft.

49. An array processing device of claim 47, wherein said disc spring-loaded mechanism comprises a single disc spring to provide a constant uniform clamping force.

50. An array processing device of claim 47, wherein said disc spring-loaded mechanism comprises a stack of multiple disc springs placed in a manner selected from the group consisting of series, parallel, and a combination of said series and said parallel to provide a constant uniform clamping force.

51. An array processing device of claim 42, wherein said seal comprises the cross-sectional geometry selected from the group consisting of a rectangular, square, circular, and oval.

52. An array processing device of claim 42, wherein said seal comprises an elastomer selected from the group consisting of silicone rubber, EPDM, and Kalrez.

53. An array processing device of claim 42, wherein said seal comprises an adhesive layer attached to said solid cover to bond said solid cover to said solid support substrate.

54. An array processing device of claim 42, wherein said solid cover is removable from the said solid support substrate.

55. An array processing device of claim 42, further comprising a heater assembly, said heater assembly used to heat said solid support substrate with to about room temperature to at least about 95° C.

56. An array processing device of claim 55, wherein said heater assembly comprises:
a. a heating element attached to a conductive metallic plate(s); and
b. a temperature sensor to measure a metallic plate temperature which is related to temperatures of said solid support substrate and an array.

57. An array processing device of claim 55, wherein said heater assembly is attached to an insulator wherein said insulator maximizes heat flow to said solid support substrate by minimizing indirect or direct heating of components surrounding said solid support substrate.

58. A method for processing a biological specimen comprising the steps of:
a. providing at least one solid support substrate;
b. providing at least one solid cover;
c. providing a compliant seal between said solid support substrate and said solid cover;
d. manually clamping said solid cover and said compliant seal to said solid support substrate with a manually applied force;
e. mechanically transforming said manually applied force to apply a mechanical clamping force to said solid support substrate; and
f. limiting said mechanical clamping force regardless of said manually applied force.

59. A method for processing a biological specimen of claim 58 further comprising the step of establishing a low coefficient relationship between said manually applied force and said mechanical clamping force.

60. A system for processing a biological specimen comprising:
a. at least one solid support substrate having an attached biological specimen;
b. at least one solid cover positioned in contact with said solid support substrate;
c. a compliant seal between said at least one solid support substrate and said at least one solid cover;
d. an actuated camshaft element contained as part of the system to bias said at least one solid support substrate to said at least one solid cover;
e. at least one disc spring-loaded element also contained as part of the system to bias said at least one solid support substrate to said at least one solid cover;
f. at least one internal chamber defined by said at least one solid support substrate, said at least one solid cover and said compliant seal; and
g. a pair of pivoting latches that provide a rigid reactionary force for the system.
